(19) United States
(12) Patent Application Publication
(10) Pub. No.: US 2007/0012746 A1
(43) Pub. Date: Jan. 18, 2007

(54) Heating type accelerator for soldering paste

(76) Inventor: Chien-Yen Lu, Taipei (TW)

Correspondence Address: G. LINK Co., LTD., 3550 Bell Road, Minooka, IL, 60447, US

(21) Appl. No.: 11/182,930

(22) Filed: Jul. 18, 2005

(51) Int. Cl. B23K 1/015; B23K 37/00

(52) U.S. Cl. 228/51; 228/53

(57) ABSTRACT

A heating type accelerator for soldering paste includes an injection part, at least a heat guiding element and at least a heating element. The injection part has a chamber inside and provides an inlet and an outlet at two lateral sides thereof to communicating with the chamber. The heat guiding element has a contact surface touching the outer surface of the injection part intimately. The heating element provides a main member to connect with the heat guiding element and generates heat to transmit heat to the heat guiding element. Further, the heat guiding element transmits heat to the injection part to heat up the soldering paste indirectly and increase fluidity the soldering paste for the soldering paste being squeezed out smoothly via the outlet.

### BACKGROUND OF THE INVENTION

1. Field of the Invention

The present invention is related to a heating type accelerator for soldering paste and particularly to a heating type accelerator applied to a soldering device filled with soldering paste.

2. Brief Description of the Related Art

The soldering paste currently used in the industry consists of tin-lead alloy or lead in the alloy is substituted with micro grains of silver/copper/zinc (so called solder powder) and then mixed with specially high viscose soldering aid paste (so called flux binder) to form gray paste. The soldering paste itself is multi-phase non-Newtonian fluid containing proprietary thixotropic agent so that the soldering paste provides a feature of being incapable of flowing easily after staying a fixed spot successfully.

That is, the soldered article is located in place temporarily with the adhesive force of the soldering paste and then the soldering paste becomes soldered spots after being heat up to high temperature. Thus, viscosity of the soldering paste affects locating property thereof. In case of the viscosity being too low, it leads to the soldering paste being difficult to locating the soldered article. Because the viscosity has relationship with the ambient temperature directly, the soldering paste should be stored in a cool place while not in use. The temperature of the soldering paste has to be lowered to the room temperature naturally or by way of stirring before being injected to the soldering cylinder. The soldering paste is squeezed out by means of air pressure to needed spots before being fixed as soldering points by means of high temperature melting.

However, deficiency of the preceding prior art is in that the soldering paste provides high viscosity at the room temperature, that is, it has low fluidity due to the soldering paste being multiphase non-Newtonian fluid containing proprietary thixotropic agent. As a result, the speed of the soldering paste being squeezed out of the soldering cylinder is slow unless the air pressure is increased such that fabrication of soldered article becomes retarded and it wastes cost.

### SUMMARY OF THE INVENTION

In order to solve the preceding problems, an object of the present invention is to provide a heating type accelerator for soldering paste with which the fluidity of the soldering paste under the room temperature is increased to shorten time of the soldering paste being squeezed.

Another object of the present invention is to provide a a heating type accelerator for soldering paste with which the air pressure for pushing the soldering paste is decreased so as to lower fabrication cost.

In order to achieve the preceding objects, the heating type accelerator for soldering paste according to the present invention includes an injection part, at least a heat guiding element and at least a heating element. The injection part has a chamber inside and provides an inlet and an outlet at two lateral sides thereof to communicating with the chamber. The heat guiding element has a contact surface touching the outer surface of the injection part intimately. The heating element provides a main member to connect with the heat guiding element and generates heat to transmit heat to the heat guiding element. Further, the heat guiding element transmits heat to the injection part to heat up the soldering paste indirectly and increase fluidity the soldering paste for the soldering paste being squeezed out smoothly via the outlet.

### BRIEF DESCRIPTION OF THE DRAWINGS

The detail structure, the applied principle, the function and the effectiveness of the present invention can be more fully understood with reference to the following description and accompanying drawings, in which:

FIG. 1 is an exploded perspective view of a heating type accelerator for soldering paste according to the present invention;

FIG. 2 is an assembled perspective view of FIG. 1;

FIG. 3 is a sectional view of FIG. 2 illustrating the heating type accelerator of the present invention in operation;

FIG. 4 is an exploded perspective view illustrating another configuration of a heat guiding element in the heating type accelerator of the present invention;

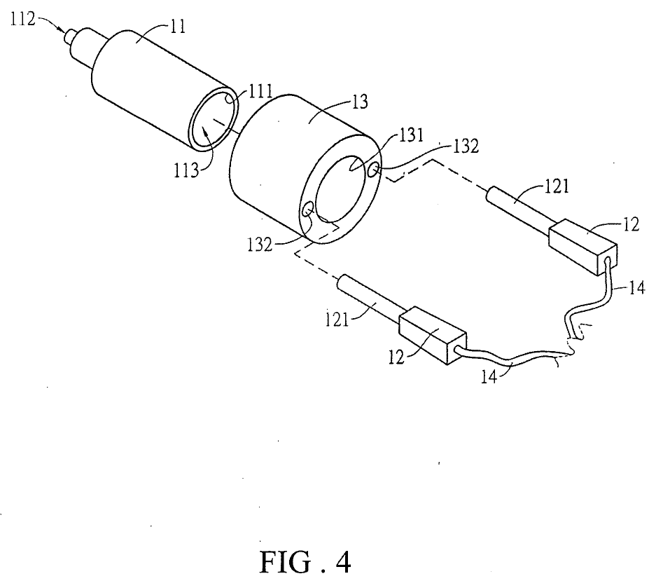

FIG. 5 is an assembled perspective view of FIG. 4; and

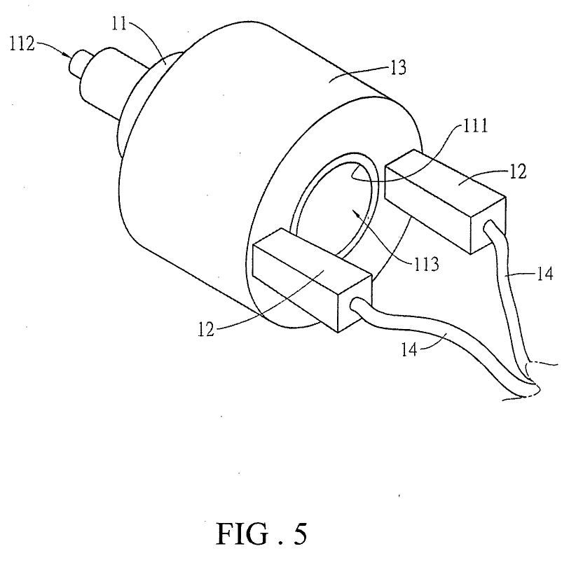

FIG. 6 is a sectional view of FIG. 5 illustrating the heat guiding element being in operation.

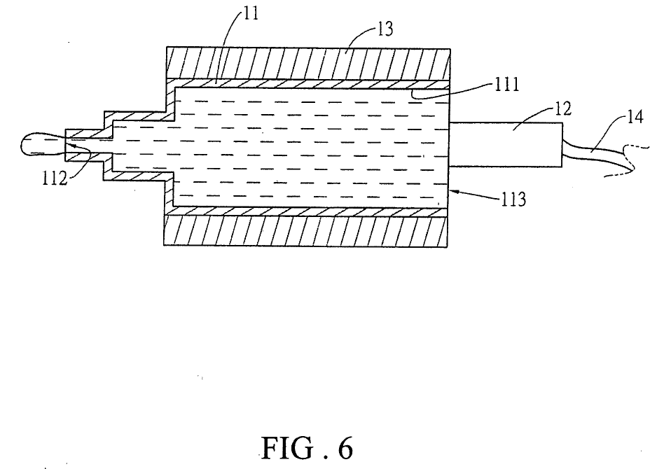

### DETAILED DESCRIPTION OF THE INVENTION

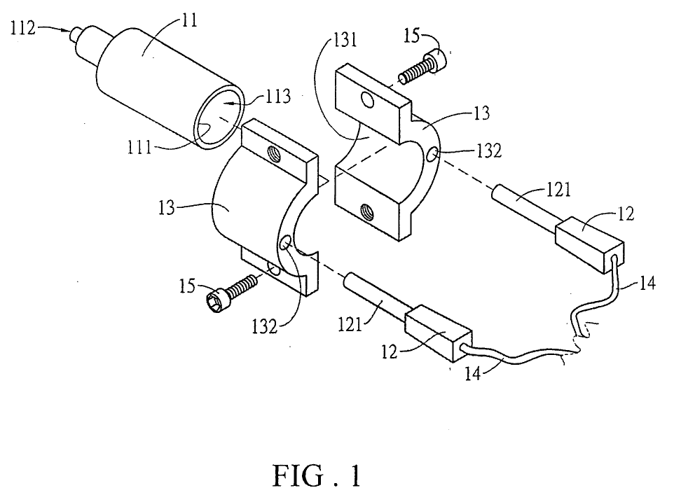

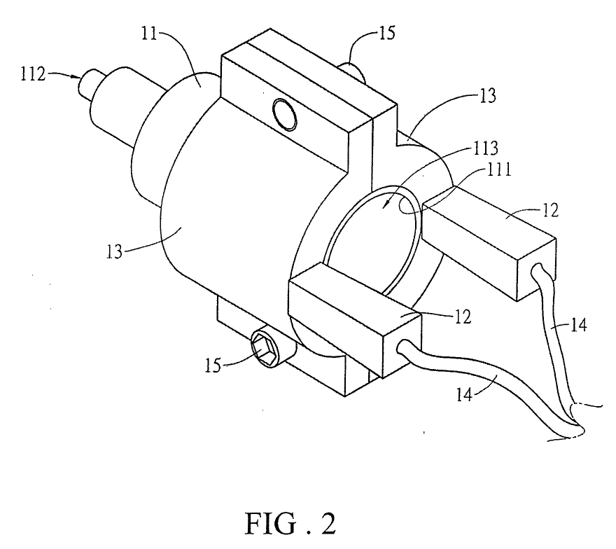

Referring to FIGS. 1 to 2, a heating type accelerator for soldering paste according to the present invention provides includes an injection part 11, at lest a heating element 12 and at least a heat guiding element 13. The injection part 11 is cylindrical with a chamber 111 inside and an inlet 112 and an outlet 113 at two lateral sides thereof respectively. The chamber 111 communicates with inlet 112 and the outlet 113 respectively.

The heating element 12 has a main member 121 and the main member 121 connects with the heat guiding element 13 to transmit heat to the heat guiding element 13.

The heat guiding element 13 has a contact surface 131 and a receiving part 132. The contact surface 131 provides a shape in accordance with the outer surface of the injection part 11 such that the contact surface 131 is capable of touching the outer surface of the injection part 11 intimately. The receiving part 132 has a shape about the same as the main member 121 of the heating element 12 so as to be inserted with the main member 121.

The heating member 12 is attached with a transmission unit 14 and it is embodied that the transmission unit 14 is an electric wire. The heating element 12 connects with at least an energy source, which is embodied as a power source, via the transmission unit. Hence, it allows the heating element 12 transferring the power source to heat energy emitting outward. Two heat guiding elements 13 are provided in the preferred embodiment to be associated with the injection part 11. The heat guiding elements 13 are made of high heat conductive material. A feasible embodiment of the high heat conductive material is metallic material to conduct heat generated by the heating element 12.

During the heat accelerator of the present invention is assembled, the contact surface 131 of each of the two heat guiding elements 13, 13 is arranged to correspond to the outer surface of the injection part 11 and a fixing element 15 passes through the respective heat guiding element 15 such that the two heat guiding elements 131, 131 cover the outer surface of the injection part 11 and the contact surfaces thereof touch the outer surface of the injection part 11 intimately. Further, the receiving parts 132, 132 of the heat guiding elements 13, 13 are inserted with the main members 121, 121 of the heating elements 12, 12.

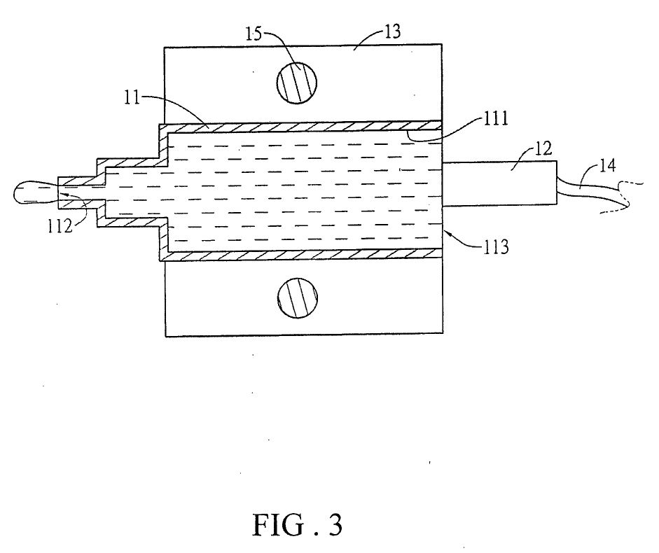

Referring to FIG. 3 in company with FIGS. 1 and 2 again, when soldering paste is injected into the chamber via the inlet 112, the energy source connected to the heating elements 12, 12 is start and results in the main members 121, 121 generating heat to heat up the heat guiding elements 13, 13. Then, the heat guiding elements 13, 13 transmit the heat to the injection part 11 to heat up the soldering paste in the chamber 111 indirectly. The soldering paste has a property to lower the viscosity value while the temperature rises such that the soldering paste becomes in a state of flowing at the time of being heat up. Under this circumference, the air pressure in the chamber 111 squeezes the soldering paste outward smoothly and rapidly and it not only shortens the time of the soldering paste being squeezed but also decreases the air pressure. Hence, the deficiency of the soldering paste uneasily flowing existing in the prior art is overcome. In addition, the heating elements 12, 12 are capable of adjusting heat thereof so that the soldering paste is incapable of overheat and characteristics of the ductility and malleability and forcibility are not lowered.

Further, it is not limited that two heat guiding elements 13 associated with one injection part 11 as the preceding description. It can be a sleeved shaped heat guiding element 13 fits with the outer surface of the injection part 11.

Furthermore, alternatively, the preceding heat guiding element 13 can be integrally made with the heating element 12 to perform the same effect.

While the invention has been described with referencing to preferred embodiments thereof, it is to be understood that modifications or variations may be easily made without departing from the spirit of this invention, which is defined by the appended claims.

1-11. (canceled)

12. A heating type accelerator for soldering paste, comprising:
a cylindrical injection part, having an end extending a reduced section, the reduced section further extending outward a reduced end with an outlet at the reduced end, another end of the injection part being an inlet and a chamber being formed inside thereof to communicate with the inlet and the outlet respectively;
two opposite heat guiding elements, each of the heat guiding elements having a semicircular cross-section with two opposite circumferential ends and two opposite longitudinal ends, providing an inner radius being the same as the radius of the outer surface of the injection part for being capable of embracing the outer surface of the injection part intimately and holding the injection part firmly in a way of one of the longitudinal ends being flush with the inlet of the injection part, having a mating section extending outward from both of the circumferential ends radially with a threaded hole piercing the middle of the mating section such that the heat guiding elements are capable of coupling to each other by means of a fastening element engaging with the threaded hole, and a receiving hole extending a depth from the middle of longitudinal end at the inlet of the injection part; and
two heating elements, each of the heating elements being elongated and extending from an end thereof a rod shaped main member corresponding to the receiving hole such that the main member is inserted into and fits with the receiving hole, and another end of the respective heating element connects with a power source via an electric wire.

13. A heating type accelerator for soldering paste, comprising:
a cylindrical injection part, having an end extending a reduced section, the reduced section further extending outward a reduced end with an outlet at the reduced end, another end of the injection part being an inlet and a chamber being formed inside thereof to communicate with the inlet and the outlet respectively;
a cylindrical heat guiding element with two opposite longitudinal ends, providing an inner diameter being the same as the diameter of the outer surface of the injection part for fitting with the injection part in a way of one of the longitudinal ends being flush with the inlet of the injection part, and two opposite receiving holes extending a depth from the longitudinal end at the inlet of the injection part; and
two heating elements, each of the heating elements being elongated and extending from an end thereof a rod shaped main member respectively corresponding to the receiving holes such that the main member is inserted into and fits with the receiving holes, and another end of the respective heating element connects with a power source via an electric wire.
